(19) United States
(12) Patent Application Publication
(10) Pub. No.: US 2025/0207977 A1
(43) Pub. Date: Jun. 26, 2025

(54) MICROBOLOMETER-BASED THERMAL IMAGING SENSOR WITH PIXELS FOR BACKGROUND TEMPERATURE COMPENSATION

(71) Applicant: Samsung Electronic Co., Ltd, Suwon-si (KR)

(72) Inventors: Se Yoon KIM, Suwon-si (KR); Ki Ho Kong, Suwon-si (KR); Jae Chul Park, Suwon-si (KR); Won Taek Seo, Suwon-si (KR); Jang Woo You, Suwon-si (KR); Du Hyun Lee, Suwon-si (KR)

(73) Assignee: Samsung Electronic Co., Ltd, Suwon-si (KR)

(21) Appl. No.: 18/622,147

(22) Filed: Mar. 29, 2024

(30) Foreign Application Priority Data
Dec. 22, 2023 (KR) 10-2023-0189154

(51) Int. Cl. G01J 5/80; G01J 5/00; G01J 5/20

(52) U.S. Cl. CPC G01J 5/80; G01J 5/20; G01J 2005/0077; G01J 2005/202

(57) ABSTRACT

A microbolometer-based thermal imaging sensor includes a pixel array including at least one first pixel, and at least one second pixel having a lower light absorbance than light absorbance of the at least one first pixel, and a processor configured to obtain a first resistance change of the at least one second pixel and obtain a second resistance change of the at least one first pixel based on the first resistance change of the at least one second pixel.

### CROSS-REFERENCE TO RELATED APPLICATION

This application is based on claims priority to Korean Patent Application No. 10-2023-0189154, filed on Dec. 22, 2023, in the Korean Intellectual Property Office, the disclosure of which is incorporated herein by reference in its entirety.

### BACKGROUND

### 1. Field

The disclosure relates to a microbolometer-based thermal imaging sensor.

### 2. Description of Related Art

A thermal imaging sensor generates image data by converting incoming light of a predetermined wavelength range into thermal energy and outputting the thermal energy.

In a microbolometer-based thermal imaging sensor, which is an uncooled-type sensor, a microbolometer is located in each pixel, and a readout integrated circuit reads out a change in current of the pixel due to a resistance change to convert the current change into a thermal image and output the image.

Generally, the microbolometer-based thermal imaging sensor includes a plurality of pixels arranged in an array, and circuits for processing measurement values are disposed adjacent to the pixels.

Only a resistance change caused by long-wave infrared (LWIR) light should be measured at each pixel, but a resistance change due to heat generated by the adjacent circuits may also be included in the measurement, negatively impacting the overall measurement.

### SUMMARY

Provided is a microbolometer-based thermal imaging sensor capable of compensation for a change in background temperature.

Additional aspects will be set forth in part in the description which follows and, in part, will be apparent from the description, or may be learned by practice of the presented embodiments of the disclosure.

According to an aspect of the disclosure, a microbolometer-based thermal imaging sensor may include a pixel array including at least one first pixel, and at least one second pixel having a lower light absorbance than light absorbance of the at least one first pixel, and a processor configured to obtain a first resistance change of the at least one second pixel and obtain a second resistance change of the at least one first pixel based on the first resistance change of the at least one second pixel.

The at least one first pixel may include a first absorber, the at least one second pixel may include a second absorber, and a size of the second absorber of the at least one second pixel may be smaller than a size of the first absorber of the at least one first pixel.

The second absorber of the at least one second pixel may include a plurality of absorber portions and a plurality of holes respectively between the plurality of absorber portions.

The first absorber of the at least one first pixel and the second absorber of the at least one second pixel may include at least one of vanadium oxide, amorphous silicon, and indium tin oxide.

A size of the at least one second pixel may be smaller than a size of at least one of the at least one first pixel.

The at least one first pixel may include a first supporting arm and a first suspended membrane and the at least one second pixel may include a second supporting arm and a second suspended membrane.

At least one of a size of the second supporting arm and a size of the second suspended membrane may be different from a respective size of the first supporting arm and a respective size of the second suspended membrane.

The pixel array may include a unit pixel array, and the at least one second pixel may be arranged in non-border positions within the unit pixel array.

The unit pixel array may include at least one of a 3×3 pixel array, 4×4 pixel array, and 6×6 pixel array.

The first resistance change may be a resistance change due to a change in background temperature, and the change in background temperature may include a temperature change caused by heat generated due to a current flowing in the pixel array and heat generated by a circuit around the pixel array.

The processor may be configured to obtain the first resistance change by subtracting a product of a predetermined constant and a reference resistance of the at least one second pixel from a third resistance change, and the third resistance change may be determined based on an amount of light absorbed by an absorber of the at least one second pixel.

The processor may be further configured to obtain a fourth resistance change by interpolating a plurality of first resistance changes, the fourth resistance change being due to a change in background temperature of the at least one first pixel, and the processor may be configured to obtain the second resistance change by subtracting the fourth resistance change from a fifth resistance change, where the fifth resistance change is determined based on an amount of light absorbed by an absorber of the at least one first pixel.

According to an aspect of the disclosure, an imaging device may include an optical lens, and a microbolometer thermal imaging sensor configured to acquire an image based on to temperature by detecting long-wave infrared (LWIR) light emitted from an object, where the microbolometer thermal imaging sensor may include a pixel array including at least one first pixel and at least one second pixel having a lower light absorbance than the at least one first pixel, and a processor configured to obtain a first resistance change of the at least one second pixel and obtain a second resistance change of the at least one first pixel based on the first resistance change of the at least one second pixel.

The at least one first pixel may include a first absorber, the at least one second pixel may include a second absorber, and a size of the second absorber of the at least one second pixel may be smaller than a size of the first absorber of the at least one first pixel.

The at least one first pixel may include a first supporting arm and a first suspended membrane, and the at least one second pixel may include a second supporting arm and a second suspended membrane.

At least one of a size of the second supporting arm and a size of the second suspended membrane may be different from a respective size of the first supporting arm and a respective size of the first suspended membrane.

The first resistance change may be a resistance change due to a change in background temperature, and the change in background temperature may be a temperature change caused by heat generated due to a current flowing in the pixel array and heat generated by a circuit around the pixel array.

According to an aspect of the disclosure, an electronic device may include a imaging device including an optical lens, and a microbolometer thermal imaging sensor configured to acquire different images based on temperature by detecting infrared light emitted from an object and a first processor configured to perform one or more image processing operations on the acquired images, where the microbolometer thermal imaging sensor may include a pixel array including at least one first pixel and at least one second pixel having a lower light absorbance than the at least one first pixel, and a processor configured to obtain a first resistance change of the at least one second pixel and obtain a second resistance change of the at least one first pixel based on the first resistance change of the at least one second pixel.

The at least one first pixel may include a first absorber, the at least one second pixel may include a second absorber, and a size of the second absorber of the at least one second pixel may be smaller than a size of the first absorber of the at least one first pixel.

The first resistance change is a resistance change due to a change in background temperature, and the change in background temperature may include a temperature change caused by heat generated due to a current flowing in the pixel array and heat generated by a circuit around the pixel array.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram illustrating a microbolometer-based thermal imaging sensor according to an embodiment of the present disclosure;

FIG. 2A is a diagram illustrating an example of a first pixel according to an embodiment of the present disclosure;

FIGS. 2B to 2D are diagrams illustrating an example of a second pixel according to an embodiment of the present disclosure;

FIGS. 3A to 3C are diagrams illustrating arrangements of first pixels and second pixels in a pixel array according to an embodiment of the present disclosure;

FIG. 4 is a block diagram illustrating a imaging device including a microbolometer thermal imaging sensor according to an embodiment of the present disclosure; and

FIG. 5 is a block diagram illustrating an electronic device including an imaging device according to an embodiment of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, example embodiments will be described in detail with reference to the attached drawings. In the drawings, like reference numerals refer to like elements throughout and sizes of constituent elements may be exaggerated for convenience of explanation and the clarity of the specification. Also, embodiments described herein may have different forms and should not be construed as being limited to the descriptions set forth herein.

It will be understood that, although the terms, “first,” “second,” etc., may be used herein to describe various elements, these elements should not be limited by these terms. These terms are only used to distinguish one element from another. Any references to singular may include plural unless expressly stated otherwise. The use of the terms “a” and “an” and “the” and similar referents are to be construed to cover both the singular and the plural. The steps of all methods described herein can be performed in any suitable order unless otherwise indicated herein or otherwise clearly contradicted by context, and are not limited to the described order.

In addition, unless explicitly described to the contrary, an expression such as “comprising” or “including” may imply the inclusion of stated elements but not the exclusion of any other elements. Also, the terms, such as “unit” or “module,” etc., should be understood as a unit that performs at least one function or operation and that may be embodied as hardware, software, or a combination thereof.

It will also be understood that when an element is referred to as being “on” or “above” another element, the element may be in direct contact with the other element or other intervening elements may be present. The singular forms include the plural forms unless the context clearly indicates otherwise. It should be understood that, when a part “comprises” or “includes” an element, unless otherwise defined, other elements are not excluded from the part and the part may further include other elements.

Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device.

The use of any and all examples, or exemplary language (e.g., “such as”) provided herein, is intended merely to better illuminate the disclosure and does not pose a limitation on the scope of the disclosure unless otherwise claimed.

A change in electrical resistance due to a temperature change caused by absorption of long-wave infrared (LWIR) light at each pixel in a microbolometer-based thermal imaging sensor may be represented by the Equation (1).

$$Δ R = Δ {R}_{IR} + Δ {R}_{0} \qquad ( 1 )$$

ΔR denotes a resistance change actually measured at each pixel, ΔRIR denotes a resistance change caused by LWIR light, and ΔR0 denotes a resistance change due to a change in background temperature. In this case, the change in background temperature may include a temperature change due to self-heating resulting from a current flowing in a pixel array, and due to heat generated by a circuit (e.g., a pixel circuit for driving an image sensor and/or a readout integrated circuit) around the pixel array.

It may be required to process only the resistance change ΔRIR caused by LWIR light in order to accurately acquire a thermal image, and thus, the resistance change ΔR0 due to the change in background temperature should be compensated based on the resistance change AR actually measured at each pixel.

A thermal imaging sensor generally performs a non-uniformity correction process of directly measuring the resistance change ΔR0 due to the change in background temperature at each pixel by eliminating LWIR light, incident from the outside, by closing a shutter at predetermined intervals. For the non-uniformity correction process, the thermal imaging sensor closes the shutter for about one second at an interval of, for example, several minutes, which may be a major obstacle to continuous thermal video recording.

In addition, a reference pixel may be located in a pixel array of the thermal imaging sensor. A reflecting plate (top mirror) for preventing the absorption of LWIR light may be mounted on top of the reference pixel, and the resistance change value ΔR0 may be measured by Equation (2).

$$Δ R = 0 \times Δ {R}_{IR} + Δ {R}_{0} \qquad ( 2 )$$

Then, based on properties that the resistance change value ΔR0 does not significantly change with position, the resistance change due to the background temperature may be compensated by applying the value ΔR0 to pixels other than the reference pixel. However, the method has a drawback in that the reference pixel corresponds to a dead pixel in terms of imaging, thereby causing thermal image distortions.

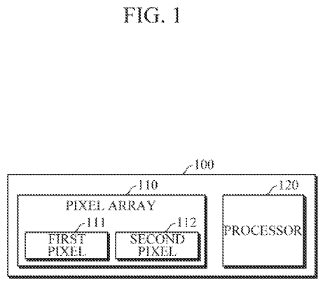

FIG. 1 is a block diagram illustrating a microbolometer-based thermal imaging sensor according to an embodiment of the present disclosure.

Referring to FIG. 1, a microbolometer-based thermal imaging sensor 100 includes a pixel array 110, which is a two-dimensional array of pixels, and a processor 120. The pixel array 110 may include a plurality of first pixels 111 and a plurality of second pixels 112 having lower light absorbance than the plurality of first pixels 111. In some examples, a pixel array 110 may include a plurality of first pixels 111 and one or more second pixels 112 having a lower light absorbance than the plurality of first pixels 111. In some examples, the number of second pixels 112 (having the lower light absorbance than the first pixels 111) may be equal to or less than the number of first pixels 111, and in other examples, the number of second pixels 112 (having the lower light absorbance than the first pixels 111) may be greater than the number of first pixels 111. While example embodiments described herein show implementations where the number of first pixels 111 is greater than the number of second pixels 112 (i.e., the second pixels 112 having the lower light absorbance than the first pixels 111), embodiments are not limited to the depicted numbers and arrangements of first pixels 111 and second pixels 112.

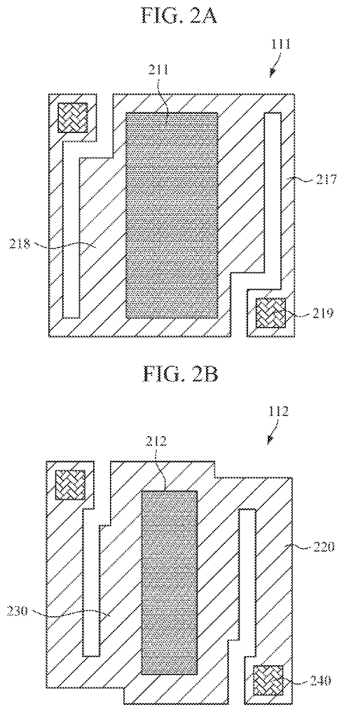

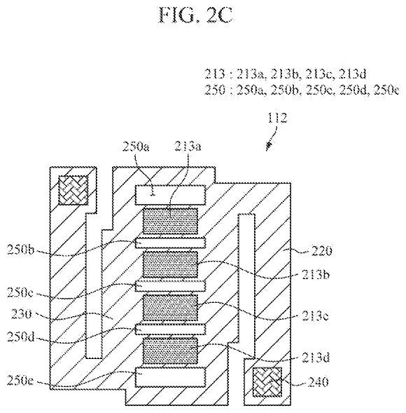

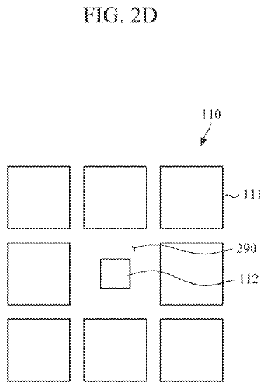

FIG. 2A is a diagram illustrating an example of a first pixel according to an embodiment of the present disclosure. FIGS. 2B to 2D are diagrams illustrating an example of a second pixel according to an embodiment of the present disclosure.

Referring to FIGS. 2A and 2B, the first pixel 111 may include an LWIR absorber 211, (hereinafter, the LWIR absorbers may be referred to as an “absorber”), a supporting arm 217, a suspended membrane 218, and a via 219. The second pixel 112 may include an LWIR absorber 212, a supporting arm 220, a suspended membrane 230, and a via 240.

A size of the absorber 212 of the second pixel 112 may be smaller than a size of the absorber 211 of the first pixel 111, such that light absorbance of the second pixel 112 may be lower than light absorbance of the first pixel 111. The absorber 211 of the first pixel 111 and the absorber 212 of the second pixel 112 may be made of at least one of vanadium oxide, amorphous silicon, and indium tin oxide.

In another example, the second pixel 112 may include a plurality of absorbers, and holes may be formed between the absorbers.

Referring to FIG. 2C, the second pixel 112 may include an absorber 213. The absorber 213 of the second pixel 112 may be divided into a plurality of portions, such as portions 213a, 213b, 213c, 213d, and a plurality of holes 250 holes 250a-250e may be formed between the portions 213a-213d and the absorber 213. Accordingly, the absorber 213 of the second pixel 112 has a smaller area than the absorber 211 of the first pixel 111, resulting in lower light absorbance.

In another example, a size of the second pixel 112 may be smaller than a size of the first pixel 111.

Referring to FIG. 2D, a size of the second pixel 112 may be relatively smaller than a size of the first pixel 111, such that light absorbance of the second pixel 112 may be lower than light absorbance of the first pixel 111. A circuit element, such as an electrode, via, etc., may be disposed in a space 290 between the second pixel 112 and the first pixel 111.

The number of first pixels 111 included in the pixel array may be larger than the number of the second pixels 112. One or more second pixels 112 may be arranged in each unit pixel array forming the pixel array. In this case, the unit pixel array may include at least one of a 3×3 pixel array, 4×4 pixel array, and 6×6 pixel array, but is not limited thereto.

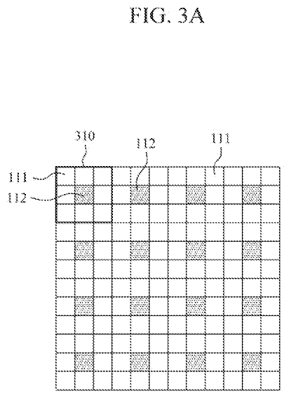

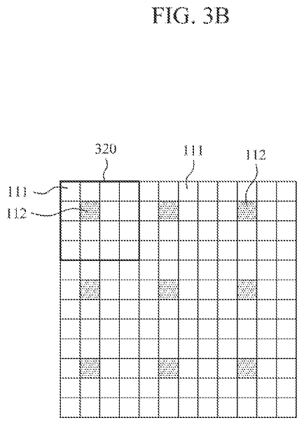

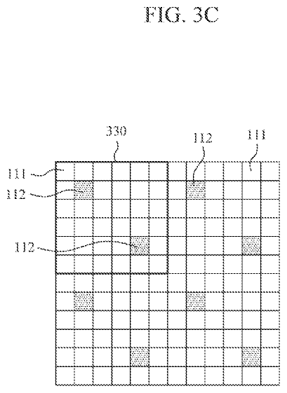

FIGS. 3A to 3C are diagrams illustrating arrangements of first pixels and second pixels in a pixel array according to an embodiment of the present disclosure.

Referring to FIG. 3A, a unit pixel array 310 is shown as a 3×3 pixel array. The second pixel 112 may be located at the center of the unit pixel array 310, and the first pixels 111 may be located at the remaining positions of the unit pixel array 310. As shown in FIG. 3A, the perimeter of the unit pixel array 310 may include first pixels 111, and a second pixel 112 may be located within the perimeter of the unit pixel array 310. In some embodiments, the second pixel 112 may be located on the perimeter of the unit pixel array 310.

Referring to FIG. 3B, a unit pixel array 320 is shown as a 4×4 pixel array. One second pixel 112 may be located at a predetermined position of the unit pixel array 320 (e.g., an interior position or a non-border position within the unit pixel array 320), and the first pixels 111 may be located at the remaining positions of the unit pixel array 320. As shown in FIG. 3B, the perimeter of the unit pixel array 320 may include first pixels 111, and a second pixel 112 may be located within the perimeter of the unit pixel array 320. In some embodiments, the second pixel 112 may be located on the perimeter of the unit pixel array 320.

Referring to FIG. 3C, a unit pixel array 330 is shown as a 6×6 pixel array. Two second pixels 112 may be located at predetermined positions of the unit pixel array 330 (e.g., the two second pixels 112 may be located at interior positions or non-border positions within the unit pixel array 330), and the first pixels 111 may be located at the remaining positions of the unit pixel array 330. As shown in FIG. 3C, the perimeter of the unit pixel array 330 may include first pixels 111, and a second pixel 112 may be located within the perimeter of the unit pixel array 330. In some embodiments, the second pixel 112 may be located on the perimeter of the unit pixel array 330.

A background temperature of the pixels does not change significantly with time and position, such that the second pixels 112, which are used as a reference for measuring the background temperature, may be sparsely located as illustrated in FIGS. 3A to 3C. The arrangement of the first pixels 111 and the second pixels 112 is not limited thereto.

The second pixel 112 may have the same thermal and electrical properties as the first pixel 111.

Although the second pixel 112 has different shape or structure from the first pixel 111, the second pixel 112 may have the same or similar thermal properties (such as the effect of background temperature in a thermal imaging sensor and the like) and the same or similar electrical properties, such as a current flowing in conducting wires, as the first pixel 111. To this end, at least one of a size of the supporting arm 220 and a size of the suspended membrane 230 of the second pixel 112 may be different from a size of the supporting arm 217 and/or a size of the suspended membrane 218 of the first pixel 111.

The processor 120 may obtain a second resistance change of the first pixel 111 based on a first resistance change obtained in each second pixel 112. In this case, the first resistance change may be a resistance change due to a change in background temperature.

For example, the processor 120 may obtain the first resistance change by subtracting the product of a predetermined constant and a reference resistance in each second pixel 112, from a third resistance change which is based on an amount of light absorbed by the absorbers 213/213 of the second pixels 112, which may be represented by the Equations (3) and (4).

$$Δ {R}^{′} = α \cdot Δ {R}_{IR}^{′} + Δ {R}_{0}^{′} \qquad ( 3 )$$

$$Δ {R}_{0}^{′} = Δ {R}^{′} - α \cdot Δ {R}_{IR}^{′} \qquad ( 4 )$$

ΔR′ denotes the third resistance change, a denotes the predetermined constant, ΔR′IR denotes the reference resistance in the second pixel 112, and ΔR′0 denotes the first resistance change, in which a is a real number greater than 0 and smaller than 1, and may reflect an absorber size that corresponds to absorbance of the second pixel 112. For example, by setting α to 0.3, the size of the absorber 212/213 of the second pixel 112 may be three-tenths (3/10) the size of the absorber 211 of the first pixel 111. Further, ΔR′IR is the reference resistance, which is a resistance change caused by long wave infrared light in the second pixel 112 and is predicted using a neural network and the like, and may be a value pre-stored in a separate storage.

Then, the processor 120 may obtain a fourth resistance change ΔR″0 according to a change in background temperature of the first pixels 111 by interpolating the first resistance change ΔR′0 obtained in the second pixels 112, and may finally obtain a second resistance change ΔR″IR of the first pixels 111 by subtracting the fourth resistance change ΔR″0 from a fifth resistance change ΔR″, which is based on an amount of light absorbed by the absorbers 211 of the respective first pixels 111, and which may be represented by the Equations (5) and (6).

$$Δ {R}^{″} = Δ {R}_{IR}^{″} + Δ {R}_{0}^{″} \qquad ( 5 )$$

$$Δ {R}_{IR}^{″} = Δ {R}^{″} - Δ {R}_{0}^{″} \qquad ( 6 )$$

ΔR″0 denotes the fourth resistance change, ΔR″ denotes the fifth resistance change, and ΔR″IR denotes the second resistance change which is finally obtained and has a compensated background temperature. The fourth resistance change ΔR″0 may be obtained by interpolating the plurality of first resistance changes ΔR′0 obtained in the second pixel 112 using, for example, three-dimensional (3D) interpolation. However, the interpolation method is not limited thereto.

Generally, a non-uniform correction method used in the thermal imaging sensor or a method of compensating for a background temperature change by placing a reflecting plate on a reference pixel causes interruptions during video recording or thermal image distortions.

In example embodiments of the present disclosure, by compensating for the background temperature change using a predetermined constant that reflects absorption of LWIR light and a reference resistance in the second pixel, interruptions during video recording caused by closing a shutter may be prevented, and a resistance change is maintained in the second pixel unlike the reference pixel, such that thermal image distortions may be reduced, and a thermal image may be generated with improved accuracy.

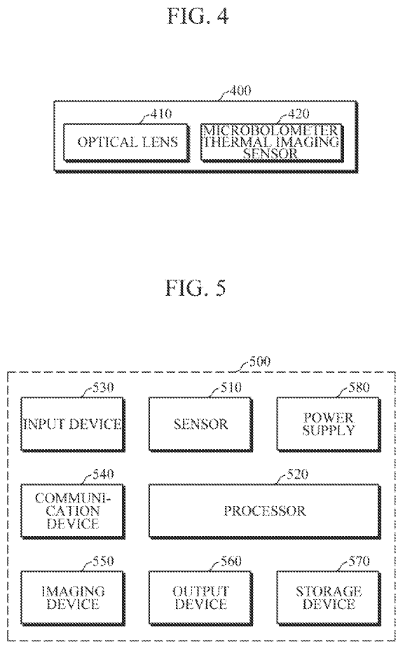

FIG. 4 is a block diagram illustrating an imaging device including a microbolometer thermal imaging sensor according to an embodiment of the present disclosure.

Referring to FIG. 4, an imaging device 400 may include an optical lens 410 and a microbolometer thermal imaging sensor 420.

The optical lens 410 may be an LWIR lens for focusing LWIR energy onto the sensor, and may be a lens made of, for example, Germanium (Ge) or Fluorite (CaF2) having a high refractive index for LWIR light.

The microbolometer thermal imaging sensor 420 may acquire an image according to temperature by detecting LWIR light emitted from an object.

The microbolometer thermal imaging sensor 420 may include a pixel array including a plurality of first pixels, and second pixels having lower light absorbance than the plurality of first pixels, and a processor configured to obtain a second resistance change of the first pixels based on a first resistance change obtained in the respective second pixels. In this case, the first resistance change refers to a resistance change due to a change in background temperature, for example, a temperature change caused by heat generated due to a current flowing in the pixel array and heat generated by a circuit around the pixel array.

The first pixel and the second pixel each may include an absorber, in which a size of the absorber of the second pixel may be smaller than a size of the absorber of the first pixel.

The second pixel may have the same or similar thermal and electrical properties as the first pixel. To this end, at least one of a size of the supporting arm and a size of the suspended membrane of the second pixel may be different from a size of the supporting arm and a size of the suspended membrane of the first pixel.

FIG. 5 is a block diagram illustrating an electronic device including an imaging device according to an embodiment of the present disclosure.

An electronic device which will be described below may include, for example, at least one of a wearable device, a smartphone, a tablet personal computer (PC), a mobile phone, a video phone, an electronic book reader, a desktop computer, a laptop computer, a netbook computer, a workstation, a server, a personal digital assistant (PDA), a portable multimedia player (PMP), an MP3 player, a medical device, and a camera (e.g., shutterless camera). The wearable device may include at least one of an accessory type wearable device (e.g., wristwatch, ring, bracelet, anklet, necklace, glasses, contact lens, or head mounted device (HMD)), a textile/clothing type wearable device (e.g., electronic clothing), a body-mounted type wearable device (e.g., skin pad or tattoo), and a body implantable type wearable device.

However, the wearable device is not limited thereto and may include, for example, various types of medical equipment including various portable medical measuring devices (antioxidant measuring device, blood glucose monitor, heart rate monitor, blood pressure measuring device, thermometer, etc.), magnetic resonance angiography (MRA), magnetic resonance imaging (MRI), computed tomography (CT), imaging system, ultrasonic system, etc.) and the like. However, the electronic device is not limited to the above devices.

Referring to FIG. 5, an electronic device 500 includes a sensor 510, a processor 520, an input device 530, a communication device 540, an imaging device 550, an output device 560, a storage device 570, and a power supply 580. The components of the electronic device 500 may be integrally mounted in a specific device, or may be distributed in two or more devices.

The sensor 510 may detect an operating state (e.g., temperature, power, etc.) of the electronic device 500 or an external environmental condition (e.g., user state), etc., and may generate an electrical signal and/or data corresponding to the detected state. The sensor 510 may include a gyro sensor, a pulse wave sensor, an acceleration sensor, a fingerprint sensor, etc., but is not limited thereto.

The processor 520 may control components connected to the processor 520 by executing programs and the like stored in the storage device 570, and may perform processing of various data or perform operations. The processor 520 may include a main processor (e.g., a central processing unit (CPU) or an application processor (AP), etc.) and an auxiliary processor, e.g., a graphics processing unit (GPU), an image signal processor (ISP), a sensor hub processor, or a communication processor (CP), which is operable independently from, or in conjunction with, the main processor, and the like.

The input device 530 may receive instructions and/or data for use in the respective components of the electronic device 500 from a user and the like. The input device 530 may include a microphone, a mouse, a keyboard, and/or a digital pen (e.g., a stylus pen, etc.), and the like.

The communication device 540 may support establishment of a direct (e.g., wired) communication channel and/or a wireless communication channel between the electronic device 500 and other electronic device, a server, or the sensor 510 within a network environment, and performing of communication via the established communication channel. The communication device 540 may include one or more communication processors that operate independently to the processor 520 and support direct communication and/or wireless communication.

The communication device 540 may include a wireless communication device, such as a cellular communication device, a short-range wireless communication device, a Global Navigation Satellite System (GNSS) communication device, etc., and/or a wired communication device, such as a local area network (LAN) communication device, a power line communication device, and the like. These various types of communication devices may be integrated into a single chip and the like, or may be implemented as a plurality of separate chips. The wireless communication device may identify and authenticate the electronic device 500 in a communication network by using subscriber information (e.g., international mobile subscriber identifier (IMSI), etc.,) stored in a subscriber identification module.

The imaging device 550 may capture still images or moving images. The imaging device 550 may include an optical lens, and a microbolometer thermal imaging sensor configured to acquire different images depending on temperature by detecting infrared light emitted from an object.

The microbolometer thermal imaging sensor may include a pixel array including a plurality of first pixels, and second pixels having lower light absorbance than the plurality of first pixels, and a processor configured to obtain a second resistance change of the first pixels based on a first resistance change obtained in the second pixels. The first resistance change may refer to a resistance change due to a change in background temperature. The first pixel and the second pixel each may include an absorber, in which a size of the absorber of the second pixel may be smaller than a size of the absorber of the first pixel.

The processor 520 may perform one or more image processing operations on the thermal image acquired by the imaging device 550.

The output device 560 may visually/non-visually output the data generated or processed by the electronic device 500. The output device 560 may include a sound output device, a display device, an audio module, and/or a haptic module.

The sound output device may output sound signals to the outside of the electronic device 500. The sound output device may include a speaker and/or a receiver. The speaker may be used for general purposes, such as multimedia playback or record playback, and the receiver may be used for incoming calls. The receiver may be implemented separately from, or as part of, the speaker.

The display device may visually provide information to the outside of the electronic device 500. The display device may include, for example, a display, a hologram device, or a projector and control circuitry to control the devices. The display device may include touch circuitry adapted to detect a touch, and/or sensor circuitry (e.g., pressure sensor, etc.) adapted to measure the intensity of force incurred by the touch.

The audio module may convert a sound into an electrical signal or vice versa. The audio module may obtain the sound via the input device, or may output the sound via the sound output device, and/or a speaker and/or a headphone of another electronic device directly or wirelessly connected to the electronic device 500.

The haptic module may convert an electrical signal into a mechanical stimulus (e.g., vibration, motion, etc.) or electrical stimulus which may be recognized by a user by tactile sensation or kinesthetic sensation. The haptic module may include, for example, a motor, a piezoelectric element, and/or an electric stimulator.

The storage device 570 may store operating conditions required for operating the sensor 510, and various data required for other components of the electronic device 500. The various data may include, for example, input data and/or output data for software and instructions related thereto. The storage device 570 may include a volatile memory and/or a non-volatile memory.

The power supply 580 may manage power supplied to the electronic device 500. The power supply may be implemented as part of, for example, a power management integrated circuit (PMIC). The power supply 580 may include a battery, which may include a non-rechargeable primary cell, a rechargeable secondary cell, and/or a fuel cell.

Example embodiments of the present disclosure may be realized as a computer-readable code written on a computer-readable recording medium. The computer-readable recording medium may be any type of recording device in which data is stored in a computer-readable manner.

Examples of the computer-readable recording medium include a read-only memory (ROM), a random access memory (RAM), a compact disc (CD) ROM (CD-ROM), a magnetic tape, a floppy disc, an optical data storage, and a carrier wave (e.g., data transmission through the Internet). The computer-readable recording medium can be distributed over a plurality of computer systems connected to a network so that a computer-readable code is written thereto and executed therefrom in a decentralized manner. Functional programs, codes, and code segments needed for realizing example embodiments of the disclosure may be readily inferred by programmers of ordinary skill in the art.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A microbolometer-based thermal imaging sensor comprising:
a pixel array comprising:
at least one first pixel; and
at least one second pixel having a lower light absorbance than light absorbance of the at least one first pixel; and
a processor configured to:
obtain a first resistance change of the at least one second pixel; and
obtain a second resistance change of the at least one first pixel based on the first resistance change of the at least one second pixel.

2. The microbolometer-based thermal imaging sensor of claim 1, wherein the at least one first pixel comprises a first absorber,
wherein the at least one second pixel comprises a second absorber, and
wherein a size of the second absorber of the at least one second pixel is smaller than a size of the first absorber of the at least one first pixel.

3. The microbolometer-based thermal imaging sensor of claim 2, wherein the second absorber of the at least one second pixel comprises a plurality of absorber portions and a plurality of holes respectively between the plurality of absorber portions.

4. The microbolometer-based thermal imaging sensor of claim 2, wherein the first absorber of the at least one first pixel and the second absorber of the at least one second pixel comprise at least one of vanadium oxide, amorphous silicon, and indium tin oxide.

5. The microbolometer-based thermal imaging sensor of claim 1, wherein a size of the at least one second pixel is smaller than a size of at least one of the at least one first pixel.

6. The microbolometer-based thermal imaging sensor of claim 1, wherein the at least one first pixel comprises a first supporting arm and a first suspended membrane, and
wherein the at least one second pixel comprises a second supporting arm and a second suspended membrane.

7. The microbolometer-based thermal imaging sensor of claim 6, wherein at least one of a size of the second supporting arm and a size of the second suspended membrane is different from a respective size of the first supporting arm and a respective size of the second suspended membrane.

8. The microbolometer-based thermal imaging sensor of claim 1, wherein the pixel array comprises a unit pixel array, and
wherein the at least one second pixel is arranged in non-border positions within the unit pixel array.

9. The microbolometer-based thermal imaging sensor of claim 8, wherein the unit pixel array comprises at least one of a 3×3 pixel array, 4×4 pixel array, and 6×6 pixel array.

10. The microbolometer-based thermal imaging sensor of claim 1, wherein the first resistance change is a resistance change due to a change in background temperature, and
wherein the change in background temperature comprises a temperature change caused by heat generated due to a current flowing in the pixel array and heat generated by a circuit around the pixel array.

11. The microbolometer-based thermal imaging sensor of claim 10, wherein the processor is configured to obtain the first resistance change by subtracting a product of a predetermined constant and a reference resistance of the at least one second pixel from a third resistance change, and
wherein the third resistance change is determined based on an amount of light absorbed by an absorber of the at least one second pixel.

12. The microbolometer-based thermal imaging sensor of claim 11, wherein the processor is further configured to obtain a fourth resistance change by interpolating a plurality of first resistance changes, the fourth resistance change being due to a change in background temperature of the at least one first pixel; and
wherein the processor is configured to obtain the second resistance change by subtracting the fourth resistance change from a fifth resistance change, wherein the fifth resistance change is determined based on an amount of light absorbed by an absorber of the at least one first pixel.

13. An imaging device comprising:
an optical lens; and
a microbolometer thermal imaging sensor configured to acquire an image based on to temperature by detecting long-wave infrared (LWIR) light emitted from an object,
wherein the microbolometer thermal imaging sensor comprises:
a pixel array comprising:
at least one first pixel; and
at least one second pixel having a lower light absorbance than the at least one first pixel; and
a processor configured to:
obtain a first resistance change of the at least one second pixel; and
obtain a second resistance change of the at least one first pixel based on the first resistance change of the at least one second pixel.

14. The imaging device of claim 13, wherein the at least one first pixel comprises a first absorber,
wherein the at least one second pixel comprises a second absorber, and
wherein a size of the second absorber of the at least one second pixel is smaller than a size of the first absorber of the at least one first pixel.

15. The imaging device of claim 13, wherein the at least one first pixel comprises a first supporting arm and a first suspended membrane, and
wherein the at least one second pixel comprises a second supporting arm and a second suspended membrane.

16. The imaging device of claim 15, wherein at least one of a size of the second supporting arm and a size of the second suspended membrane is different from a respective size of the first supporting arm and a respective size of the first suspended membrane.

17. The imaging device of claim 13, wherein the first resistance change is a resistance change due to a change in background temperature, and
wherein the change in background temperature comprises a temperature change caused by heat generated due to a current flowing in the pixel array and heat generated by a circuit around the pixel array.

18. An electronic device comprising:
a imaging device comprising an optical lens, and a microbolometer thermal imaging sensor configured to acquire different images based on temperature by detecting infrared light emitted from an object; and
a first processor configured to perform one or more image processing operations on the acquired images,
wherein the microbolometer thermal imaging sensor comprises:
a pixel array comprising:
at least one first pixel; and
at least one second pixel having a lower light absorbance than the at least one first pixel; and
a second processor configured to:
obtain a first resistance change of the at least one second pixel; and
obtain a second resistance change of the at least one first pixel based on the first resistance change of the at least one second pixel.

19. The electronic device of claim 18, wherein the at least one first pixel comprises a first absorber,
wherein the at least one second pixel comprises a second absorber, and
wherein a size of the first absorber of the at least one second pixel is smaller than a size of the second absorber of the at least one first pixel.

20. The electronic device of claim 18, wherein the first resistance change is a resistance change due to a change in background temperature, and
wherein the change in background temperature comprises a temperature change caused by heat generated due to a current flowing in the pixel array and heat generated by a circuit around the pixel array.
